(19) United States
(12) Patent Application Publication
(10) Pub. No.: US 2005/0014894 A1
(43) Pub. Date: Jan. 20, 2005

(54) Room temperature curable organopolysiloxane compositions

(76) Inventors: William Tait Flannigan, Somerset (GB); Martin Brandon Ridley, North Somerset (GB)

Correspondence Address: PATTON BOGGS, 1660 LINCOLN ST, SUITE 2050, DENVER, CO, 80264, US

(21) Appl. No.: 10/495,019

(22) PCT Filed: Aug. 29, 2002
(86) PCT No.: PCT/GB02/03940

(51) Int. Cl. C08L 83/04

(52) U.S. Cl. 524/864; 524/863; 524/860

(57) ABSTRACT

A RTV organopolysiloxane composition comprising (A) an organopolysiloxane having at least two hydroxyl groups attached to the terminal silicon atoms of the molecule, (B) finely divided silicon dioxide, (C) an amino-functional silane containing at least one amino-group per molecule, (D) a silane crosslinking agent, (E) a trialkoxysilane, and (F) an organic imine or substituted imine.

### FIELD OF THE INVENTION

This invention generally relates to a process for producing room temperature, moisture curable organopolysiloxane compositions for use as adhesive sealants and coatings. Specifically, this invention relates to room temperature vulcanisable (RTV) organopolysiloxane compositions which are readily cured in the presence of atmospheric moisture to form elastomers and more specifically, to such RTV compositions which are curable into rubbery elastomers having improved primeness adhesion and non-corrosive properties to sensitive substrates which are otherwise difficult to bond.

### PROBLEM

Room temperature vulcanisable (curable) compositions (known as RTVs) based on the so-called condensation reactions of silanes and hydroxyl-terminated organopolysiloxanes are well known to those in the art. These compositions are cured by exposure to atmospheric moisture to form elastomeric materials that are widely used as adhesive sealants, gaskets and potting agents in a wide variety of applications ranging from electrical and electronics to aerospace and construction.

Many silicone sealants are unsuitable for certain applications because of their corrosive effects on sensitive metals such as copper and its alloys. These silicone sealants, typically including an amino-functional silane as an internal adhesion promoter, have been shown to cause corrosion on copper and its alloys often in the presence of certain crosslinking agents and organometallic catalysts.

Further, many silicone sealants are unsuitable for some applications due to their limited adhesion to various substrates. These substrates often require priming to achieve satisfactory adhesion. Priming substrates is disadvantageous from the time and cost standpoints.

Finally, most catalysts used in silicone sealants are organometallic compounds, the most common of which are organo-tin substances. Many such catalysts are classified as “harmful to the environment”, whilst many organo-tin catalysts may also exhibit toxic and/or irritant characteristics. Organometallic catalysts, such as dibutyltin dilaurate and tetra-butyl titanate, have also been shown to cause premature gelation and curing of sealants of the type described.

Information relevant to attempts to address these problems can be found in U.S. Pat. Nos. 5,969,075 issued 19 Oct. 1999 to Inoue; 4,487,907 issued 11 Dec. 1984 to Fukayama, et al.; 5,525,660 issued 11 Jun. 1996 to Shiono, et al.; 6,214,930 issued 10 Apr. 2001 to Miyake, et al. and 4,973,623 issued 27 Nov. 1990 to Haugsby, et al. However, each one of these references suffers from one or more of the following disadvantages: priming of substances prior to application of the silicone sealant and corrosive properties of the silicone sealant.

### SOLUTION

The above-described problems are solved and a technical advance achieved by the present RTV organopolysiloxane composition including a novel combination of a crosslinking component and non-organometallic curing catalyst.

The purpose of this invention is to provide a method of preparing silicone adhesive sealants that cure at room temperature in the presence of atmospheric moisture, possess excellent primeness adhesion to many substrates and do not exhibit corrosive properties towards copper, its alloys and other commonly used metals/plastics.

The invention describes a means of preparing and curing a condensation-cure, one-component silicone adhesive sealant without the use of organometallic catalysts. The invention uses an organic imine catalyst, such as 1,1,3,3-Tetramethylguanidine, thereby removing the need for organometallic catalysts. In conjunction with certain alkoxysilanes the organic imine obviates the need for an extremely expensive and complex guanidyl silane.

These sealants offer good shelf-life stability and relatively fast curing properties.

The present RTV organopolysiloxane composition consists of a number of components, which are combined in the manner described below to produce a condensation-cure, one-component silicone adhesive sealant without the use of organometallic catalysts. These components include an organopolysiloxane having at least two hydroxyl groups attached to the terminal silicon atoms of the molecule, combined with a silica filler that is added to provide physical strength to the cured elastomer. In addition, an amino-functional silane, an organic imine catalyst and a silane crosslinking agent are added to the composition. Additional components may be added to the composition to control the rate of cure of the sealants of this invention and snappiness of the cured elastomer, and to provide other desirable properties as described below.

### DETAILED DESCRIPTION

The present RTV organopolysiloxane composition consists of a number of components, which are combined in the manner described below to produce a condensation-cure, one-component silicone adhesive sealant without the use of organometallic catalysts. The present invention is a RTV organopolysiloxane composition comprising (A) an organopolysiloxane having at least two hydroxyl groups attached to the terminal silicon atoms of the molecule, (B) finely divided silica filler, (C) an amino-functional silane containing at least one amino-group per molecule, (D) a silane crosslinking agent, (E) a trialkoxysilane, and (F) an organic imine or substituted imine.

Component (A) is an organopolysiloxane having at least two hydroxyl groups attached to the terminal silicon atoms of the molecule. Preferably, it is an organopolysiloxane blocked with a hydroxyl group at either end represented by the following formula (1).

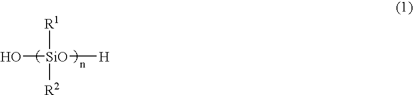

In formula (1), groups R¹ and R², which may be the same or different, are independently selected from substituted or unsubstituted monovalent hydrocarbon groups having 1 to 10 carbon atoms, for example methyl, ethyl, propyl, butyl, cyclohexyl, vinyl, allyl, phenyl, tolyl, benzyl, octyl, 2-ethylhexyl or groups such as trifluoropropyl or cyanoethyl. The preferred groups are methyl. The latter may be substituted by trifluoropropyl or phenyl to impart specific properties to the cured elastomer. Letter n is such an integer that the diorganopolysiloxane may have a viscosity of 50 to 500,000 mPa.s at 25° C., preferably 2,000 to 100,000 mPa.s. Blends of differing viscosities may be used to achieve a desired effect.

Component (B) is finely divided silicon dioxide that is added to provide physical strength to the cured elastomer. Examples of suitable silica fillers include fumed silica, fused silica, precipitated silica and powdered quartz, which are optionally surface treated with silazanes, chlorosilanes or organopolysiloxanes to render them hydrophobic. The preferred silicas are those having a specific surface area of at least 50 m²/g as measured by the BET method. The above silicas may be blended in any desired ratio.

In order to achieve the desired physical properties in the cured elastomer; an appropriate amount of Component (B), about 1 to 40 parts by weight, is blended into 100 parts by weight of Component (A) until a smooth, agglomerate-free dispersion in obtained.

Component (C) is an amino-functional silane containing at least one amino-group per molecule. Illustrative examples of the amino-functional silane are given below. The amino-functional silane is provided to promote adhesion between the sealant and inorganic and/or organic substrates. Component (C) is a compound of the following formula:

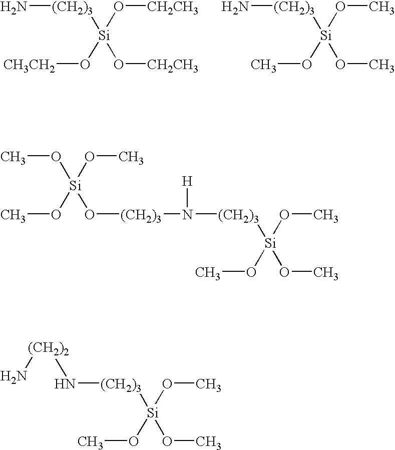

Suitable silanes are available from Crompton OSi Specialities under the trade identity: Silane A-1100: γ-aminopropyltriethoxysilane, Silane A-1110: γ-aminopropyltrimethoxysilane, Silane A-1120: β-aminoethyl-γ-aminopropyltrimethoxysilane, Silane A-1130: Triaminofunctional silane, Silane Y-9669: N-phenyl-γ-aminopropyltrimethoxysilane, Silane A-1170: Bis-[γ-(trimethoxysilyl) propyl]amine and Silane A-2120: N-β-aminoethyl-γ-aminopropylmethyldimethoxysilane.

Component (D) is a silane crosslinking agent represented by the following formula (2).
RₙSiX₄₋ₙ (2)

In formula (2) R represents a substituted or unsubstituted monovalent hydrocarbon group of 1 to 10 carbon atoms, X is a 1-methyvinyloxy (also known as isopropenyloxy) group, and letter n is equal to 0, 1 or 2. Preferably, the silane crosslinking agent is selected from methyl tris-isopropenyloxy silane, vinyl tris-isopropenyloxy silane, phenyl tris-isopropenyloxy silane or combinations of the aforesaid crosslinking agents.

Component (E) is a trialkoxysilane that is employed to control the rate of cure of the sealants of this invention and snappiness of the cured elastomer. Component (E) is represented by formula (3)
RₚSiX₄₋ₚ (3)
In formula (3) R represents a methyl, phenyl, vinyl or substituted vinyl group and X is a methoxy or ethoxy group or a mixture of methoxy and ethoxy groups. Letter p is equal to 0, 1 or 2. Some examples of suitable silanes are available from Compton OSi Specialities under the trade identity: Silane A-162: Methyltriethoxysilane, Silane A-163: Methyltrimethoxysilane, Silane A-151: Vinyltriethoxysilane, Silane A-171: Vinyltrimethoxysilane and also Phenyltriethoxysilane, Phenyltrimethoxysilane from Lancaster Synthesis.

Component (F) is an organic imine or a substituted imine, which is used as a catalyst and is of the general formulas (4a) and (4b): 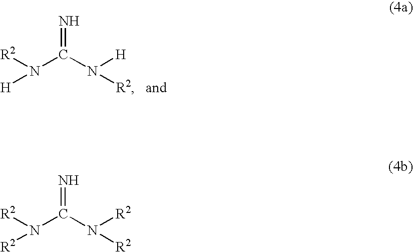
wherein R² is independent and selected from methyl, isopropyl, phenyl and ortho-tolyl groups. Some examples of the organic imine or substituted imine include: 1,3-Diphenylguanidine, 1,3-Di-o-tolylguanidine, 1,3-Dimethylguanidine and 1,1,3,3-Tetramethylguanidine. The preferred compound is 1,1,3,3-Tetramethylguanidine.

Other materials such as bulking fillers, for example micronised quartz, calcium carbonate, talc, magnesium oxide, aluminium oxide and aluminosilicates may be used insofar as the main properties of the sealants are not affected. Useful additives such as iron oxide, titanium dioxide and cerium oxide for thermal stability; fungicidal compounds for extended protection; carbon black, titanium dioxide and other coloured pigments to enhance appearance and fire retardant compounds may be used. Such additives are normally added following addition of Component (B).

Examples of the invention are given below by way of illustration and not by way of limitation. All parts are by weight. The viscosity is a measurement at 25° C. using a Brookfield Rotary Spindle Viscometer.

### EXAMPLE 1

A uniform mixture was prepared by blending 100 parts of a hydroxyl-terminated polydimethylsiloxane polymer with a viscosity of approximately 50,000 mPa.s with 100 parts of a second hydroxyl-terminated polydimethylsiloxane polymer of viscosity of approximately 10,000 mPa.s (Components A). To the above blend of polymers was added 17.2 parts by weight of hydrophobised fumed silica (Degussa R972). The latter was mixed into the polymer blend until a smooth, agglomerate-free dispersion was obtained. 7.4 parts of a hydrophobised fumed silica (Cab-O-Sil LM150) was added to the above filler dispersion and mixed until fully dispersed (These fillers are Components B). 4.9 parts of carbon black masterbatch was added to the polymer/filler dispersion and blended until a uniform mixture was obtained. This mixture is called Dispersion 1.

A sealant, Example 1(a) according to the invention, and a comparative sealant 1(b) were prepared by adding each of the components shown in Table 1 in the order given.

TABLE 1

Example

| (Parts by weight) | 1(a) | 1(b) |
|---|---|---|
| Dispersion 1 | 100 | 100 |
| Vinyl tris-isopropenyloxy silane | 6.30 | — |
| Vinyltrimethoxysilane | 0.30 | — |
| Methyl tris-(2-butanoximo)silane | — | 3.75 |
| Vinyl tris-(2-butanoximo)silane | — | 0.55 |
| γ-aminopropyltriethoxysilane | 1.07 | 0.55 |
| Dibutyltin dilaurate | — | 0.05 |
| 1,1,3,3-Tetramethylguanidine | 0.44 | — |

The above formulations were semi-flowable products with a slump in excess of 10 mm when tested on a Boeing Jig. They were stable for at least 12 months at ambient temperatures and exhibited no significant change in properties after storing at 40° C. for 3 months.

The results of the following tests, carried out to test the suitability of the products for electronic applications are summarised in Table 2:

Tack Free Time. The time taken for the sealant to form a dry non-adherent skin on the surface following exposure to atmospheric moisture.

Cure Through Time. This is considered to be the time taken after exposure to atmospheric moisture for the sealant to cure to a depth of 3 mm.

Adhesion/Corrosion. The substrates chosen are stainless steel, aluminium, polyester powder coated metal, copper and brass. Corrosion was assessed on a scale of 1 to 5. The higher the mark the worse the corrosive properties.

General Physical Properties as shown in Table 2. Samples were examined for the mode of adhesive failure and for any corrosive action or surface attack.

TABLE 2

Example

| Test | 1(a) | 1(b) |
|---|---|---|
| Tack Free Time, min | 3 to 4 | 9 to 10 |
| Cure Through, hours | <16 | 24 |
| Tensile Strength, MPa | ˜1.2 | 1.3 |
| Elongation at Break, % | ˜180 | 210 |
| Hardness, Shore A | 40 | 35 |

| Adhesion- | Fail Mode | Corrosion | Fail Mode | Corrosion |
|---|---|---|---|---|
| Stainless Steel | Cohesive | 1 | Cohesive | 1 |
| Aluminium | Cohesive | 1 | Cohesive | 1 |
| PC Polyester | Cohesive | 1 | Cohesive | 2 |
| Copper | Cohesive | 1 | Cohesive | 5 |
| Brass | Cohesive | 1 | Cohesive | 4 |

### EXAMPLE 2

A uniform mixture was prepared by blending 50 parts of a hydroxyl-terminated polydimethylsiloxane polymer with a viscosity of approximately 50,000 mPa.s with 100 parts of a second hydroxyl-terminated polydimethylsiloxane polymer of viscosity of approximately 10,000 mpa.s (Components A). To the above blend of polymers was added 15.0 parts by weight of hydrophobised fumed silica (Degussa R972). The latter was mixed into the polymer blend until a smooth, agglomerate-free dispersion was obtained. 6.0 parts of a hydrophilic fumed silica (Cab-O-Sil LM150) was added to the above filler dispersion and mixed until fully dispersed (These fillers are Components B). 3.0 parts of carbon black masterbatch was added to the polymer/filler dispersion and blended until a uniform mixture was obtained. This mixture is called Dispersion 2.

A sealant, Example 2(a) according to the invention and a comparative sealant 2(b) were prepared by adding each of the components shown in Table 3 in the order given. The test results are given in Table 3.

TABLE 3

Example

| (Parts by weight) | 2(a) | 2(b) |
|---|---|---|
| Dispersion 2 | 100 | 100 |
| Vinyl tris-isopropenyloxy silane | 6.35 | — |
| Vinyltrimethoxysilane | 0.30 | — |
| Methyl tris-(2-butanoximo)silane | — | 3.75 |
| Vinyl tris-(2-butanoximo)silane | — | 0.55 |
| γ-aminopropyltriethoxysilane | 0.55 | 0.55 |
| Dibutyltin dilaurate | — | 0.05 |
| 1,1,3,3-Tetramethylguanidine | 0.44 | — |

The above formulations were semi-thixotropic products with a slump in the order of 8-10 mm when tested on a Boeing Jig. They were stable for at least 12 months at ambient temperatures and exhibited no significant change in properties after storing at 40° C. for 3 months. Samples were examined for the mode of adhesive failure and for any corrosive action or surface attack. The results are summarised in Table 4.

TABLE 4

Example

| Test | 2(a) | 2(b) |
|---|---|---|
| Tack Free Time, min | 3 to 4 | 9 to 10 |
| Cure Through, hours | <16 | 24 |
| Tensile Strength, MPa | ˜2.2 | 2.3 |
| Elongation at Break, % | ˜270 | 210 |
| Hardness, Shore A | 45 | 40 |

| Adhesion- | Fail Mode | Corrosion | Fail Mode | Corrosion |
|---|---|---|---|---|
| Stainless Steel | Cohesive | 1 | Cohesive | 1 |
| Aluminium | Cohesive | 1 | Cohesive | 1 |
| PC Polyester | Cohesive | 1 | Cohesive | 2 |
| Copper | Cohesive | 1 | Cohesive | 5 |
| Brass | Cohesive | 1 | Cohesive | 4 |

### EXAMPLE 3

A uniform mixture was prepared by blending 32 parts of a hydroxyl-terminated polydimethylsiloxane polymer with a viscosity of approximately 50,000 mPa.s with 20 parts of a second hydroxyl-terminated polydimethylsiloxane polymer of viscosity of approximately 10,000 mPa.s (Components A). To the above blend of polymers was added 4.5 parts by weight of hydrophobised fumed silica (Degussa R972). The latter was mixed into the polymer blend until a smooth, agglomerate-free dispersion was obtained. 165 parts of a blend of aluminium oxides (Alcan aluminas) was added to the above filler dispersion and mixed until fully dispersed. This mixture is called Dispersion 3.

A sealant, Example 3(a) according to the invention and a comparative sealant 3(b) were prepared by adding each of the components shown in Table 5 in the order given.

TABLE 5

Example

| (Parts by weight) | 3(a) | 3(b) |
|---|---|---|
| Dispersion 3 | 100 | 100 |
| Vinyl tris-isopropenyloxy silane | 2.45 | — |
| Methyl tris-(2-butanoximo)silane | — | 2.20 |
| Vinyl tris-(2-butanoximo)silane | — | 0.50 |
| γ-aminopropyltriethoxysilane | 0.50 | 0.50 |
| Dibutyltin dilaurate | — | 0.05 |
| 1,1,3,3-Tetramethylguanidine | 0.20 | — |

The above formulations were semi-flowable products with a slump in excess of 10 mm when tested on a Boeing Jig. They were stable for at least 12 months at ambient temperatures and exhibited no significant change in properties after storing at 40° C. for 3 months. Samples were examined for the mode of failure and for any corrosive action or surface attack. The results are summarised in Table 6.

TABLE 6

Example

| Test | 3(a) | 3(b) |
|---|---|---|
| Tack Free Time, min | 4 to 5 | 9 to 10 |
| Cure Through, hours | <20 | 24 |
| Hardness, Shore A | 85 | 85 |
| Thermal Conductivity, W/m · K | ˜1.5 | ˜1.5 |

| Adhesion- | Fail Mode | Corrosion | Fail Mode | Corrosion |
|---|---|---|---|---|
| Aluminium | Cohesive | 1 | Cohesive | 1 |
| Copper | Cohesive | 1 | Cohesive | 5 |
| Brass | Cohesive | 1 | Cohesive | 4 |

### EXAMPLE 4

A uniform mixture was prepared by blending 42.0 parts of a hydroxyl-terminated polydimethylsiloxane polymer with a viscosity of approximately 50,000 mPa.s with 24.0 parts of a second hydroxyl-terminated polydimethylsiloxane polymer of viscosity of approximately 10,000 mpa.s (Component A). To the above blend of polymers was added 5.8 parts by weight of hydrophobised fumed silica (Degussa R972). The latter was mixed into the polymer blend until a smooth, agglomerate-free dispersion was obtained. 209 parts by weight of a blend of 5 to 95 parts aluminium oxide and 95 to 5 parts aluminium nitride was added to the above filler dispersion and mixed until fully dispersed. This mixture is called Dispersion 4.

A sealant, Example 4(a) according to the invention and a comparative sealant 4(b) were prepared by adding each of the components shown in Table 7 in the order given.

TABLE 7

Example

| (Parts by weight) | 4(a) | 4(b) |
|---|---|---|
| Dispersion 4 | 100 | 100 |
| Vinyl tris-isopropenyloxy silane | 2.45 | — |
| Methyl tris-(2-butanoximo)silane | — | 2.20 |
| Vinyl tris-(2-butanoximo)silane | — | 0.50 |
| γ-aminopropyltriethoxysilane | 0.50 | 0.50 |
| Dibutyltin dilaurate | — | 0.05 |
| 1,1,3,3-Tetramethylguanidine | 0.20 | — |

The above formulations were semi-flowable products with a slump in excess of 10 mm when tested on a Boeing Jig. They were stable at ambient temperatures and exhibited no significant change in properties after storing at 40° C. for 3 months. Samples were examined for the mode of adhesive failure and for any corrosive action or surface attack. The results are summarised in Table 8

TABLE 8

Example

| Test | 4(a) | 4(b) |
|---|---|---|
| Tack Free Time, min | 1 to 3 | 9 to 10 |
| Cure Through, hours | <18 | 24 |
| Hardness, Shore A | 66 | 85 |
| Thermal Conductivity, W/m · K | ˜1.9 | ˜1.9 |

| Adhesion- | Fail Mode | Corrosion | Fail Mode | Corrosion |
|---|---|---|---|---|
| Aluminium | Cohesive | 1 | Cohesive | 1 |
| Copper | Cohesive | 1 | Cohesive | 5 |
| Brass | Cohesive | 1 | Cohesive | 4 |

### SUMMARY

The present invention is a RTV organopolysiloxane composition comprising (A) an organopolysiloxane having at least two hydroxyl groups attached to the terminal silicon atoms of the molecule, (B) finely divided silicon dioxide, (C) an amino-functional silane containing at least one amino-group per molecule, (D) a silane crosslinking agent, (E) a trialkoxysilane, and (F) an organic imine or substituted imine. Component (E) may be added to control the crosslink density of the composition as required. The RTV organopblysiloxane adhesive sealants so produced exhibit non-corrosive and primeness properties.

Although there has been described what is at present considered to be the preferred embodiments of the present invention, it will be understood that the invention can be embodied in other specific forms without departing from the spirit or essential characteristics thereof. The present embodiments are, therefore, to be considered in all aspects as illustrative and not restrictive. The scope of the invention is indicated by the appended claims rather than the foregoing description.

1. A RTV organopolysiloxane composition having improved non-corrosive properties and being free from organometallic catalysts, comprising as their main components:
(A) an organopolysiloxane polymer molecule containing at least two hydroxyl groups each attached to the terminal silicon atoms in said molecule and that the organopolysiloxanes used may have a viscosity from 50 to 500,000 mPa.s at 25° C.;
(B) finely divided silica filler;
(C) an amino-functional silane or derivative of such substances;
(D) an organic silicon compound of the following formula (I):
RₙSiX₄₋ₙ (I)
wherein R is a substituted or unsubstituted monovalent hydrocarbon group of 1 to 10 carbon atoms, X is a 1-methylvinyloxy group, and letter n is equal to 0,1 or 2;
(E) an organic silicon compound of the following formula (II):
R¹ₚSiX₄₋ₚ (II)
wherein R¹ is a methyl, phenyl, vinyl or substituted vinyl group and X is methoxy or ethoxy or a mixture of methoxy and ethoxy, letter p is equal to 0, 1 or 2; and
(F) an organic imine curing catalyst of the following formulas (IIIa) and (IIIb): 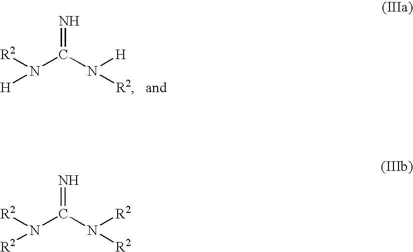
wherein each R² is independently selected from the group consisting of methyl, isopropyl, phenyl and ortho-tolyl groups.

2. The RTV organopolysiloxane composition of claim 1, wherein said component (A) comprises a organopolysiloxane described by formula (IV) 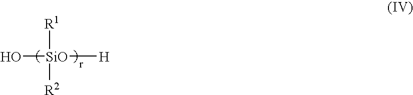
wherein R¹ and R² may be the same or different and are independently selected from group consisting of methyl, ethyl, propyl, butyl, cyclohexyl, vinyl, allyl, tolyl, phenyl, benzyl, octyl, 2-ethylhexyl, trifluoropropyl and cyanoethyl and r is such a number to provide an organopolysiloxane that exhibits said viscosity.

3. The RTV organopolysiloxane composition of claim 1, wherein said component (A) comprises at least two organopolysiloxane polymer molecules having a viscosity of about 100 to 100,000 mPa.S. at 25° C.

4. The RTV organopolysiloxane composition of claim 1, wherein said component (B) is selected from the group consisting of fused silica, fumed silica, precipitated silica and powdered quartz.

5. The RTV organopolysiloxane composition of claim 1, wherein said component (C) is selected from the group consisting of γ-aminopropyltriethoxysilane, γ-aminopropyltrimethoxysilane, β-aminoethyl-γ-aminopropyltrimethoxysilane, Triaminofunctional silane, N-phenyl-γ-aminopropyltrimethoxysilane, Bis-[γ-(trimethoxysilyl) propyl]amine and N-γ-aminoethyl-γ-aminopropylmethyldimethoxysilane.

6. The RTV organopolysiloxane composition of claim 1, wherein said component (C) is γ-aminopropyltriethoxysilane.

7. The RTV organopolysiloxane composition of claim 1, wherein said component (D) is selected from the group consisting of vinyl tris-isopropenyloxy silane, methyl tris-isopropenyloxy silane and phenyl tris-isopropenyloxy silane.

8. The RTV organopolysiloxane composition of claim 1, wherein said component (D) is vinyl tris-isopropenyloxy silane.

9. The RTV organopolysiloxane composition of claim 1, wherein said component (E) is selected from the group consisting of methyltriethoxysilane, methyltrimethoxysilane, phenytrimethoxysilane, phenyltriethoxysilane, vinyltriethoxysilane and vinyltrimethoxysilane.

10. The RTV organopolysiloxane composition of claim 1, wherein said component (E) is vinyltrimethoxysilane.

11. The RTV organopolysiloxane composition of claim 1, wherein said component (F) is selected from the group consisting of 1,3-diphenylguanidine, 1,3-di-o-tolylguanidine, 1,3-dimethylguanidine and 1,1,3,3-tetramethylguanadine.

12. The RTV organopolysiloxane composition of claim 1, wherein said component (F) is 1,1,3,3-tetramethylguanadine.

13. A RTV organopolysiloxane composition having improved non-corrosive properties and being free from organometallic catalysts made by combining:
(A) about 100 parts by weight of an organopolysiloxane polymer molecule containing at least two hydroxyl groups each attached to the terminal silicon atoms in said molecule and having a viscosity of about 50 to 500,000 mPa.s at 25° C.;
(B) 1 to 20 parts by weight of a finely divided silicon dioxide;
(C) 0.1 to 5.0 parts by weight of an amino-functional silane or derivative of such substances;
(D) 1.0 to 10.0 parts by weight of an organic silicon compound of the following formula (I):
RₙSiX₄₋ₙ (I)
wherein R is a substituted or unsubstituted monovalent hydrocarbon group of 1 to 10 carbon atoms, X is a 1-methylvinyloxy group, and letter n is equal to 0,1 or 2;
(E) 0 to 1.0 parts by weight of an organic silicon compound of the following formula (II):
R¹ₚSiX₄₋ₚ (II)
wherein R¹ is a methyl, phenyl, vinyl or substituted vinyl group and X is methoxy or ethoxy or a mixture of methoxy and ethoxy, letter p is equal to 0, 1 or 2; and
(F) 0.1 to 3.0 parts by weight of an organic imine curing catalyst of the following formulas (IIIa) and (IIIb): 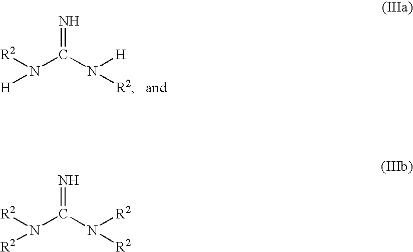
wherein each R² is independently selected from the group consisting of methyl, isopropyl, phenyl and ortho-tolyl groups.
